(19) United States
(12) Patent Application Publication
(10) Pub. No.: US 2022/0129628 A1
(43) Pub. Date: Apr. 28, 2022

(54) ARTIFICIAL INTELLIGENCE SYSTEM FOR BUSINESS PROCESSES

(71) Applicant: USERBOT S.r.l., Milano (IT)

(72) Inventors: Antonio GIARRUSSO, Milano (IT); Marco MURACCHIOLI, Milano (IT); Ricardo Antonio PIANA, Milano (IT)

(73) Assignee: USERBOT S.r.l., Milano (IT)

(21) Appl. No.: 17/422,184

(22) PCT Filed: Jan. 10, 2020
(86) PCT No.: PCT/IB2020/050178

§ 371 Date: Jul. 10, 2021

(30) Foreign Application Priority Data
Jan. 11, 2019 (IT) 102019000000526

(51) Int. Cl. G06F 40/253; G06F 40/30; G06N 5/04; G06N 20/00

(52) U.S. Cl. CPC G06F 40/253; G06N 20/00; G06N 5/04; G06F 40/30

(57) ABSTRACT

An artificial intelligence system for business processes comprises an input unit connected to a communication network and configured to receive a conversational input comprising a sentence; a decision-making engine configured to receive at input the sentence and to select an adequate reply from a database of possible replies or, in the case of absence of an adequate reply, to send an absent reply signal; an automatic reply unit configured to receive at input the selected adequate reply and to send the adequate reply to an output unit connected to the communication network; an operator interface unit connected to the output unit and configured to be activated in case of an absent reply signal for the generation of a manual reply by one or more operators in charge or for the manual selection of an adequate reply already present in the database.

### TECHNICAL FIELD

The present invention relates to an artificial intelligence system for business processes.

### BACKGROUND ART

With reference to help services provided by companies to their customers, an increasing need is felt to provide users with a service which is available 24/7 and which, at the same time is able to quickly answer questions and, above all, solve users' problems quickly and effectively.

It is well known that one of the preferred tools of users to communicate with companies is “live chat”, inasmuch as it is more immediate than an email and more convenient than a phone call.

The use of “live chats” does however have some drawbacks.

Companies find in fact extremely difficult if not impossible to guarantee a constantly operational help service with very short response times through the use of human operators only, inasmuch as this would necessarily imply an extremely high number of trained operators.

In order to overcome this drawback, the use is known in live chats of so-called “chatbots”, i.e. software designed to simulate a conversation with a human being.

However, today's chatbots use outdated technology and are nothing more than simple automatic answering machines devoid of artificial intelligence. In particular, chatbots are based on simple rules, with the result that when you break those rules on which the chatbot has been trained, inaccurate or even wrong answers are provided, and the quality of the user help service ends up being considerably worsened.

### DESCRIPTION OF THE INVENTION

The main aim of the present invention is to devise an artificial intelligence system for business processes capable of allowing a continuous and high quality help service to users and which, at the same time, minimizes the need for human interventions.

The above objects are achieved by the present artificial intelligence system for business processes according to claim 1.

### BRIEF DESCRIPTION OF THE DRAWINGS

Other characteristics and advantages of the present invention will become more evident from the description of a preferred but not exclusive embodiment of an artificial intelligence system for business processes, illustrated only by way of an indicative yet non-limiting example in the accompanying tables of drawings, in which:

FIG. 1 is a general diagram of the system according to the invention;

FIG. 2 is a general functional diagram of a sentiment module of the system according to the invention;

FIG. 3 is a general functional diagram of a NER module of the system according to the invention;

FIG. 4 illustrates a general diagram of a decision-making engine of the system according to the invention;

FIG. 5 illustrates a possible and preferred embodiment of the decision-making engine of the system according to the invention;

FIG. 6 illustrates a general functional diagram of a self-learning unit of the system according to the invention.

### EMBODIMENTS OF THE INVENTION

With particular reference to these figures, reference numeral 1 globally indicates an artificial intelligence system for business processes.

The system 1 according to the invention uses artificial intelligence to automatically interact with users (specifically customers of a company) on digital channels.

The system 1 uses technologies such as Machine Learning, Deep Learning, Artificial Intelligence and Sentiment Analysis in order to interpret the natural language used by the users and can answer the questions on which it has been trained in total autonomy.

Advantageously, if the system 1 is faced with a question or problem that generally speaking has never been addressed before, then the system 1 is configured to automatically request the intervention of a human operator and to self-learn from the operator's replies.

Advantageously, the system 1 is configured to operate through any type of dialogue interface, such as, for example, chat, telephony, interview, email, documents, images and videos.

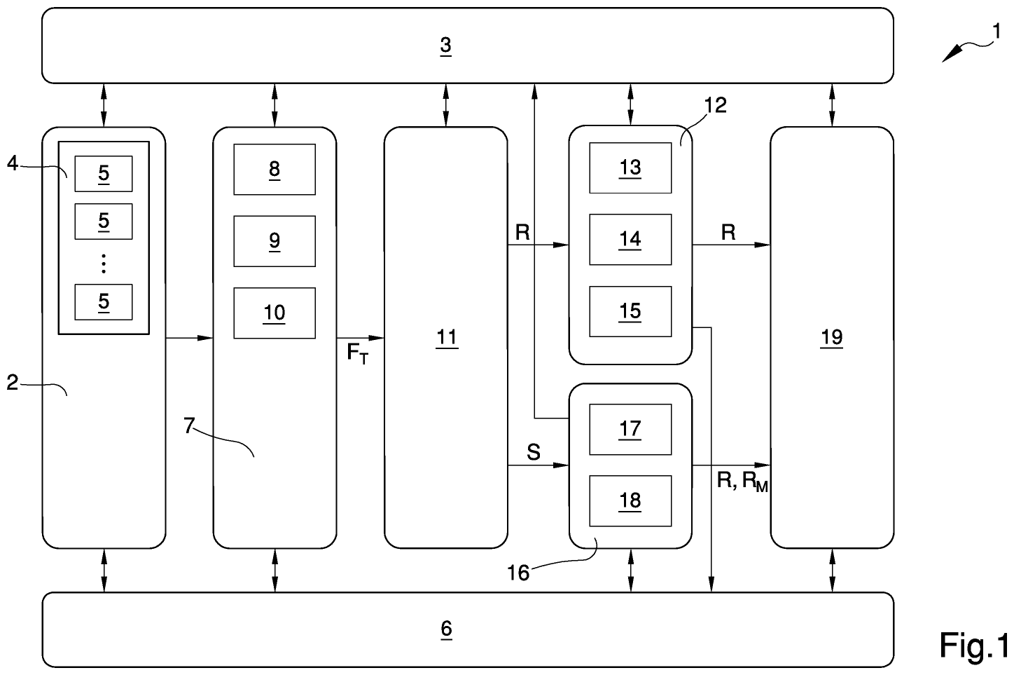

In particular, as schematically shown in FIG. 1, the system 1 comprises an input unit 2 connected to a communication network 3 (e.g. a computer network) and configured to receive at least one conversational input 4 comprising at least one sentence 5.

The conversational input 4 passes through all the units of the system 1, constantly connected to the communication network 3 and constantly stored on a database 6.

According to a preferred embodiment, the system 1 also comprises at least one pre-processing unit 7 configured to receive the conversational input 4 and to transform and classify each sentence in order to obtain a sentence in a predefined format.

In particular, the pre-processing unit 7 comprises at least one language processing module 8 which is configured to perform at least the following steps:
automatic spell-checking;
isolation of variable parts (numbers, dates, tax codes, city names, postal codes etc.);
POS syntactic analysis (Part of speech Tagging, it extracts for each word its syntactic meaning in CONLL format);
stemmer (reduces the language to a simpler one with fewer words or synonyms).

Furthermore, according to a preferred embodiment, the pre-processing unit 7 comprises at least one sentiment module 9 configured to perform the calculation of the sentiment of the sentence at input.

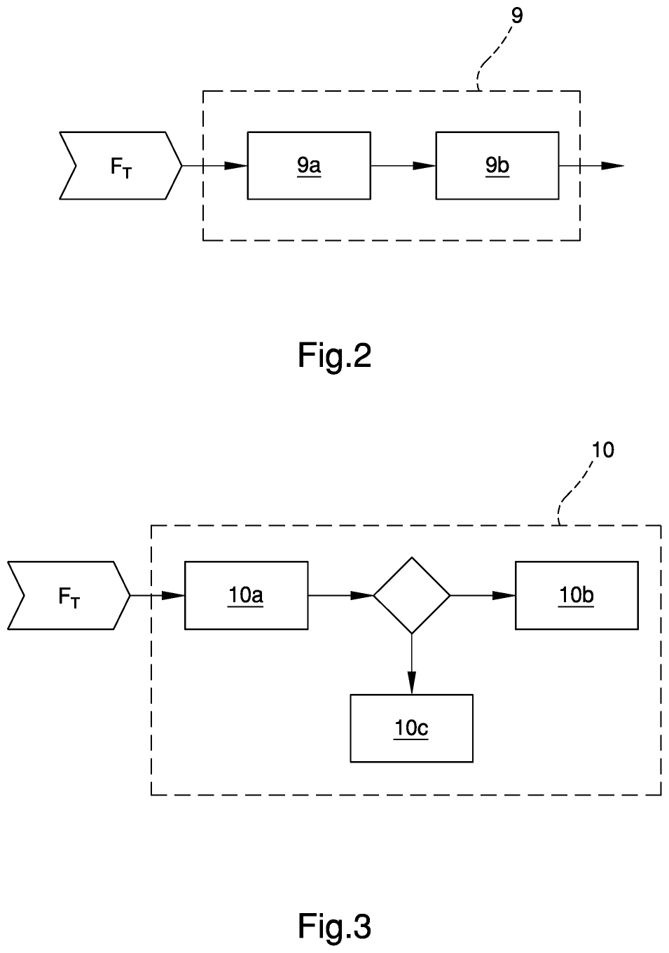

A general functional diagram of the sentiment module 9 is illustrated in FIG. 2.

As schematized in FIG. 2, the sentiment module 9 is configured to receive at input the sentence F_{T} transformed into a predefined format, coming from the pre-processing unit 8.

The sentiment module 9 comprises a classifier block 9a configured to assign a positive, negative or neutral value to each word of the sentence F_{T}.

For example, with reference to a possible embodiment, the classifier block 9a can consist of a statistical sentiment analysis system based on a public linguistic corpus. The corpus is a commented text based on the extraction of words from various sources and the statistical cataloguing of words with a positive or negative value between +5 and −5 based on the text sentiment.

Moreover, the sentiment module 9 comprises a calculation block 9b configured to determine a total score of the sentence F_{T} which is normalized to the average value starting from said positive, negative or neutral value for each word of the sentence F_{T}.

In practice, therefore, the words of the sentence F_{T} undergoing stemming are compared with the vocabulary obtaining a numerical value indicating whether the sentence is positive, neutral or negative.

Furthermore, according to a possible embodiment, the pre-processing unit 7 is configured to determine a macro-category of intents to be sent to the decision-making engine 11 to guide it in its choice.

In particular, the pre-processing unit 7 comprises a NER (Name Entity Recognition) module, indicated in FIG. 1 as a whole with reference numeral 10.

As schematically shown in FIG. 3, the NER module 10 is configured to perform at least the following steps:
to receive at input the sentence F_{T} transformed into a predefined format coming from the pre-processing unit 8;
to check whether there is a match between a macro-category predefined to such sentence F_{T}, wherein such macro-category is selected from a set of possible macro-categories stored on said database 6 (step 10a);
if a corresponding macro-category exists, to load at least one decision-making engine 11 configured to manage such macro-category (step 10b);
if there is no corresponding macro-category, to use the conventional decision-making engine 11 (step 10c).

Conveniently, the result of each step performed by the pre-processing unit 7 is stored in the database 6 of the system 1.

Advantageously, the system 1 comprises a decision-making engine 11 configured to receive at input the sentence F_{T} in a predefined format and to select, by means of a processing of the neural or functional type, an adequate reply R to such sentence from a database of possible replies or, in the case of absence of an adequate reply, to send an absent reply signal S.

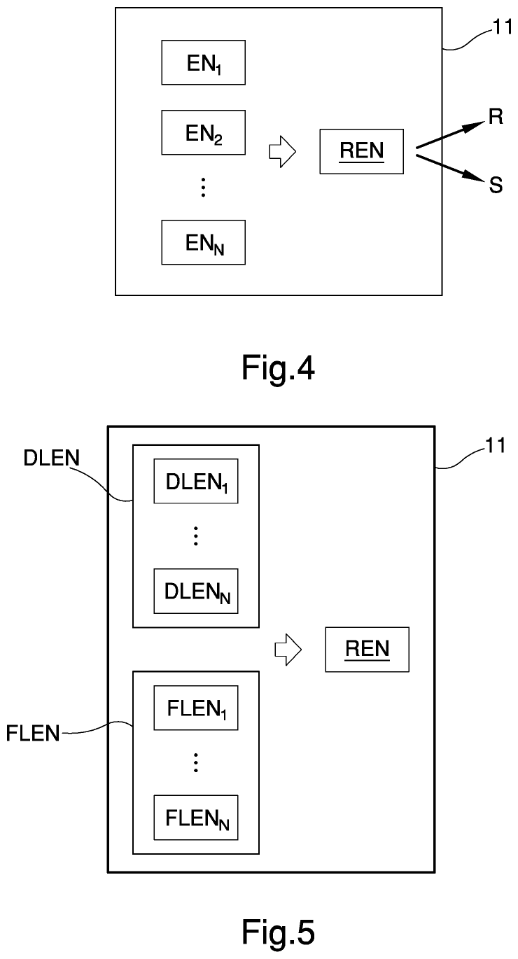

A general diagram of the decision-making engine 11 is illustrated by way of example in FIG. 4.

Preferably, the decision-making engine 11 comprises a plurality of processing modules EN₁-EN_{N} configured to receive a question at input and to return at output possible replies associated with a respective value of confidence.

The processing modules EN₁-EN_{N} can be launched in parallel or in sequence.

The decision-making engine 11 returns at output the best reply R from those obtained from all the processing modules EN₁-EN_{N}.

Alternatively, if none of the processing modules EN₁-EN_{N} returns a reply, the decision-making engine 11 returns an absent reply signal S.

Usefully, with reference to a possible embodiment, the decision-making engine 11 also comprises a recovery engine REN configured to be queried if none of the processing modules EN₁-EN_{N} returns a reply, and configured to verify the existence of similar questions and to provide a possible reply, if any exists.

In this case, if the recovery engine REN is also unable to provide a reliable reply R, the decision-making engine 11 returns an absent reply signal S.

Furthermore, the system 1 comprises an automatic reply unit 12 configured to receive at input the selected adequate reply R and to send such adequate reply R to an output unit 19 connected to the communication network 3.

In particular, the automatic reply unit 12 comprises an AI reply block 13 configured to prepare the reply to be sent to the output unit 19.

The reply can be text, interactive, input forms or multimedia content of various kinds. In the case of forms, the entered data are processed to be communicated to an operator or to external systems by means of saving on database or API call.

In addition, the automatic reply unit 12 comprises a self-training block 14.

In practice, if the confidence of the adequate reply R returned by the decision-making engine 11 is very high, the self-training block 14 records the question and reply on the database 6 as automatically belonging to the training examples and informs the decision-making engines so they practice online learning or subsequent training on it; improving the information set each time.

Furthermore, the automatic reply unit 12 comprises at least one analytical module 15 for the statistical analysis of the collected data, preferably also in the form of graphs.

Advantageously, the system 1 comprises an operator interface unit 16 connected to the output unit 19 and configured to be activated in case of an absent reply signal S for the generation of a manual reply R_{M} by one or more operators in charge or for the manual selection of an adequate reply R already present in the database 6.

In addition, the operator interface unit 16 comprises a self-learning unit 17 configured to receive at input the manual reply R_{M} generated and configured to record it on the database 6 as a possible adequate reply R to the analyzed sentence F_{T}.

Alternatively, if the adequate reply R is manually selected from among those already on the database 6, such reply is recorded as a possible adequate reply to the analyzed sentence F_{T}.

In practice, therefore, if the decision-making engine 11 determines that it cannot reply by means of an adequate reply R, the system 1 passes the conversation to a connected human operator from among those available at the moment (or puts it in a queue known as a depot waiting for a human operator to take charge of the conversation). The operator replies using the operator interface unit 16 by autonomously chatting with the user.

Using the self-learning unit 17, the system 1 takes note of the replies and of the entire conversation for further learning, subject to approval and modification by an authorized operator.

The presence of the self-learning unit 17 represents a clear advantage, inasmuch as the system 1 according to the invention is able to self-learn the adequate replies R, becoming in time increasingly less dependent on the need for a manual reply by an operator.

According to a further possible embodiment, if the decision-making engine 11 is not able to provide a reliable reply R, it can provide at least one reply R closest to the reliable one.

Preferably, the decision-making engine 11 provides a plurality of replies R close to the reliable one (e.g. three different replies).

In this case, the users shall be able to give positive or negative feedback on the replies proposed by the decision-making engine 11.

In case of positive feedback, the assumed reply R is associated with the analyzed sentence F_{T} and is stored in the database 6 in a “to be approved” section.

A human operator can then approve or not approve such a reply R as the reliable reply to the analyzed sentence F_{T}.

The final approval by the human operator can then allow the further addition of reliable replies R for the training of the system 1, thus improving the reply efficiency over time.

Advantageously, in order to make self-learning as effective as possible, the system 1 provides a particular embodiment of the decision-making engine 11.

This possible and preferred embodiment of the decision-making engine 11 is shown in FIG. 5.

According to such embodiment, the decision-making engine 11 comprises:
a deep learning engine DLEN, with long learning times;
a fast learning engine FLEN, with short learning times (within minutes or hours).

Preferably, the deep learning engine DLEN comprises a plurality of respective processing modules DLEN₁-DLEN_{N}.

Similarly, the fast learning engine FLEN comprises a plurality of respective processing modules FLEN₁-FLEN_{N}.

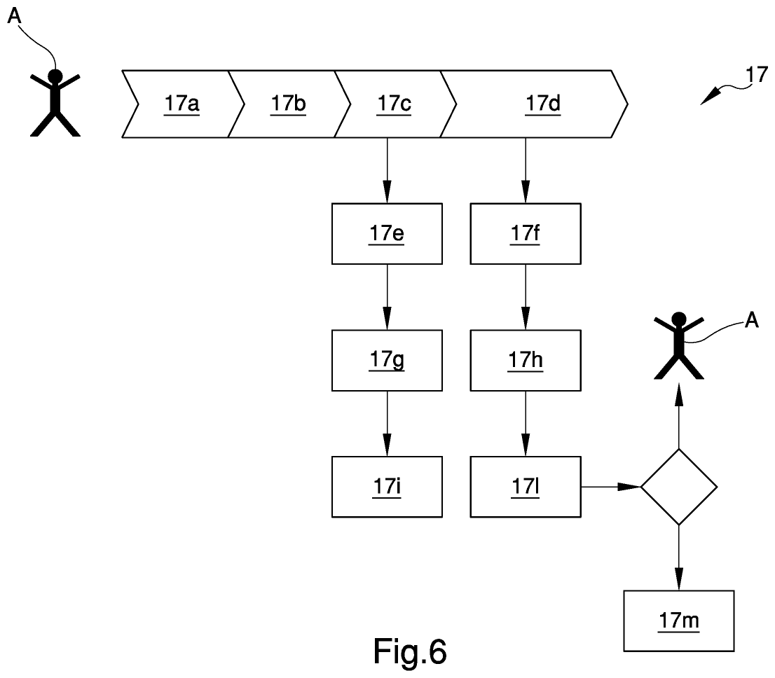

A general diagram of the learning phase by means of the self-learning unit 17 is shown in FIG. 6.

By means of the possible support of a trainer A, the self-learning unit 17 stores the analyzed sentences F_{T} and the respective adequate replies R on the database 6 (step 17a).

Subsequently, the recovery engine REN verifies whether previously analyzed similar sentences F_{T} already exist (step 17b).

The self-learning unit 17 then launches the training queue of the fast learning engine FLEN (step 17c) and the training queue of the deep learning engine DLEN (step 17d).

Conveniently, the self-learning unit 17 comprises a manager of the fast learning queues 17e and a manager of the deep learning queues 17f, configured to store a plurality of sentences F_{T} and of respective adequate replies R to be processed.

In addition, the self-learning unit 17 comprises a first training module 17g of the fast learning engine FLEN, operationally connected to the manager of fast learning queues 17e.

Similarly, the self-learning unit 14 comprises a second training module 17h of the deep learning engine DLEN, operationally connected to the manager of deep learning queues 17f.

Advantageously, the manager of fast learning queues 17e is configured to launch the training of the fast learning engine FLEN at a predefined frequency higher than the training frequency of the deep learning engine DLEN. This way, the fast learning engine FLEN is able to provide replies during the training of the deep learning engine DLEN.

After the training of the fast learning engine FLEN, the self-learning unit 17 activates the engine (step 17i).

Conveniently, after the training of the deep learning engine DLEN, the self-learning unit 17 performs a test set of all stored sentences and related replies to identify possible conflicts with those to be stored (step 17l).

In case of any conflicts, it informs a trainer A.

On the contrary, in case of no conflicts, it activates the deep learning engine DLEN (step 17m).

Conveniently, furthermore, the operator interface unit 16 comprises a manual learning unit 18 configured to approve, modify and improve the set of sentences and possible replies stored in the database 6 on the basis of the conversations between the user and the automatic reply unit 12, between user and operator, or to create new sentences and possible replies.

According to a possible embodiment, the invention consists of a multimedia totem comprising a touch screen and at least one processing unit, of the type of a computer or the like, operationally connected to the touch screen and configured to implement the artificial intelligence system described above.

The totem can for example be positioned inside physical stores and can be used by users to ask for information about the availability or location of products (both vocally and textually).

It has in practice been ascertained that the described invention achieves the intended objects.

In particular, the fact is underlined that the artificial intelligence system for business processes according to the invention is able to guarantee a continuous and high-quality help service to users and, at the same time, is able to minimize the need for human intervention.

1) An artificial intelligence system for business processes, an artificial intelligence system comprising:
an input unit connected to a communication network and configured to receive at least one conversational input comprising at least one sentence;
a decision-making engine configured to receive at input said sentence and to select an adequate reply to said sentence from a database of possible replies or, in the case of absence of an adequate reply, to send an absent reply signal;
an automatic reply unit configured to receive at input said selected adequate reply and to send said adequate reply to an output unit connected to said communication network; and
an operator interface unit connected to said output unit and configured to be activated in case of an absent reply signal for the generation of a manual reply by one or more operators in charge or for the manual selection of an adequate reply already present in said database.

2) The artificial intelligence system according to claim 1, further compromising:
at least one self-learning unit configured to receive at input said manual reply generated by means of said operator interface unit and configured to record on said database said manual reply as a possible adequate reply to said sentence.

3) The artificial intelligence system according to claim 2, further comprising:
at least one pre-processing unit configured to receive said conversational input and to transform and classify said sentence in order to obtain a sentence in a predefined format.

4) The artificial intelligence system according to claim 3, wherein said pre-processing unit is configured to perform at least the following steps:
automatic spell-checking;
isolation of variable parts;
POS syntactic analysis; and
stemmer.

5) The artificial intelligence system according to the claim 4, wherein said pre-processing unit comprises at least one sentiment module configured to perform the calculation of the sentiment of said sentence at input.

6) The artificial intelligence system according to claim 5, wherein said sentiment module comprises a classifier block configured to assign a positive, negative or neutral value to each word of said sentence and a calculation block configured to determine a total score of the sentence which is normalized to the average value starting from said positive, negative or neutral value for each word of said sentence.

7) The artificial intelligence system according to claim 6, wherein said pre-processing unit comprises at least one NER module.

8) The artificial intelligence system according to claim 7, wherein said automatic reply unit comprises an AI reply block configured to prepare the reply to be sent to the output unit.

9) The artificial intelligence system according to claim 8, wherein said automatic reply unit comprises a self-training block.

10) The artificial intelligence system according to claim 9, wherein said automatic reply unit comprises at least one analytical module for the statistical analysis of the collected data.

11) The artificial intelligence system according to claim 10, wherein said operator interface unit comprises a manual learning unit configured to approe, modify and improve the set of sentences and possible replies stored in the database on the basis of the conversations between the user and the automatic reply unit, between user and operator, or to create new sentences and possible replies.

12) A multimedia totem comprising:
a touch screen and at least one processing unit which is operationally connected to said touch screen and configured to implement said artificial intelligence system according to claim 1.

13) The artificial intelligence system according to claim 1, further comprising:
at least one pre-processing unit configured to receive said conversational input and to transform and classify said sentence in order to obtain a sentence in a predefined format.

14) The artificial intelligence system according to claim 13, wherein said pre-processing unit is configured to perform at least the following steps:
automatic spell-checking;
isolation of variable parts;
POS syntactic analysis; and
stemmer.

15) The artificial intelligence system according to claim 3, wherein said pre-processing unit comprises at least one sentiment module configured to perform the calculation of the sentiment of said sentence at input.

16) The artificial intelligence system according to claim 15, wherein said sentiment module comprises a classifier block configured to assign a positive, negative or neutral value to each word of said sentence and a calculation block configured to determine a total score of the sentence which is normalized to the average value starting from said positive, negative or neutral value for each word of said sentence.

17) The artificial intelligence system according to claim 3, wherein said pre-processing unit comprises at least one NER module.

18) The artificial intelligence system according to claim 1, wherein said automatic reply unit comprises an AI reply block configured to prepare the reply to be sent to the output unit.

19) The artificial intelligence system according to claim 1, wherein said automatic reply unit comprises a self-training block.

20) The artificial intelligence system according to claim 1, wherein said operator interface unit comprises a manual learning unit configured to approve, modify and improve the set of sentences and possible replies stored in the database on the basis of the conversations between the user and the automatic reply unit, between user and operator, or to create new sentences and possible replies.
